(19) United States
(12) Patent Application Publication
(10) Pub. No.: US 2022/0130271 A1
(43) Pub. Date: Apr. 28, 2022

(54) PILOT TRAINING SUPPORT APPARATUS

(71) Applicant: SUBARU CORPORATION, Tokyo (JP)

(72) Inventor: Shunichiro HARA, Tokyo (JP)

(21) Appl. No.: 17/491,063

(22) Filed: Sep. 30, 2021

(30) Foreign Application Priority Data
Oct. 23, 2020 (JP) 2020-177741

(51) Int. Cl. G09B 9/08; G06Q 50/20

(52) U.S. Cl. CPC G09B 9/08; G06Q 50/205

(57) ABSTRACT

A pilot training support apparatus includes a piloting skill measurer, a pilot aptitude measurer, a training proficiency level determiner, and a curriculum creator. The piloting skill measurer is to generate technical skill data obtainable by quantifying a piloting skill of a subject in piloting an airplane based on measurement data related to the piloting skill of the subject. The pilot aptitude measurer is to generate non-technical skill data obtainable by quantifying a pilot aptitude of the subject based on measurement data related to the pilot aptitude of the subject. The training proficiency level determiner is to determine a training proficiency level of the subject by comparing the technical skill data and the non-technical skill data with reference values related to a training proficiency level. The curriculum creator is to create a curriculum of training content for the subject in accordance with the training proficiency level of the subject.

### CROSS-REFERENCE TO RELATED APPLICATIONS

The present application claims priority from Japanese Patent Application No. 2020-177741 filed on Oct. 23, 2020, the entire contents of which are hereby incorporated by reference.

### BACKGROUND

The disclosure relates to a pilot training support apparatus that supports training of pilots.

A drive simulator with which a driver can virtually experience driving of a vehicle or the like has been used for improving the driving technique of the driver (for example, see Japanese Unexamined Patent Application Publication No. 2001-318585).

### SUMMARY

An aspect of the disclosure provides a pilot training support apparatus including a piloting skill measurer, a pilot aptitude measurer, a training proficiency level determiner, and a curriculum creator. The piloting skill measurer is configured to generate technical skill data obtainable by quantifying a piloting skill of a subject in piloting an airplane based on measurement data related to the piloting skill of the subject. The pilot aptitude measurer is configured to generate non-technical skill data obtainable by quantifying a pilot aptitude of the subject based on measurement data related to the pilot aptitude of the subject. The training proficiency level determiner is configured to determine a training proficiency level of the subject by comparing the technical skill data and the non-technical skill data with reference values related to a training proficiency level. The curriculum creator is configured to create a curriculum of training content for the subject in accordance with the training proficiency level of the subject.

An aspect of the disclosure provides a pilot training support apparatus including circuitry. The circuitry is configured to generate technical skill data obtainable by quantifying a piloting skill of a subject in piloting an airplane based on measurement data related to the piloting skill of the subject. The circuitry is configured to generate non-technical skill data obtainable by quantifying a pilot aptitude of the subject based on measurement data related to the pilot aptitude of the subject. The circuitry is configured to determine a training proficiency level of the subject by comparing the technical skill data and the non-technical skill data with reference values related to a training proficiency level. The circuitry is configured to create a curriculum of training content for the subject in accordance with the training proficiency level of the subject.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to explain the principles of the disclosure.

FIG. 1 is a block diagram for explaining a configuration of a pilot training support apparatus;

FIG. 2 is a diagram for explaining quantification of a piloting skill and quantification of a pilot aptitude;

FIG. 3 is an explanatory diagram for explaining training proficiency level determination and curriculum creation; and

FIG. 4 is an explanatory diagram for explaining suitable course determination.

### DETAILED DESCRIPTION

In recent years, it is currently requested to train pilots in the aviation industry due to shortage of pilots.

However, currently, improvement in the training efficiency of trainees of airplanes has been insufficient, and the dismissal rate of trainees has been high.

It is desirable to provide a pilot training support apparatus capable of reducing the dismissal rate and improving the training efficiency of trainees of airplanes.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

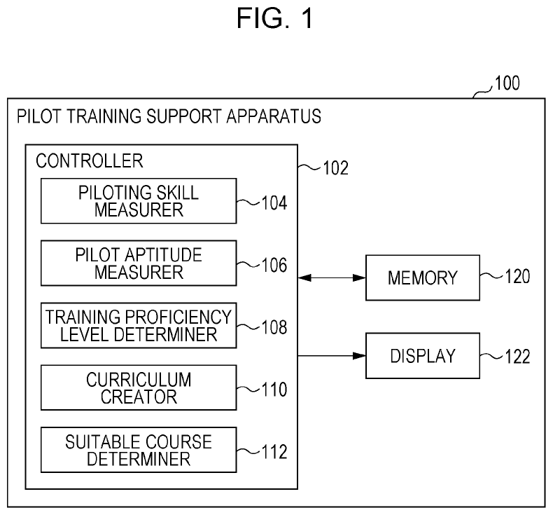

FIG. 1 is a block diagram for explaining a configuration of a pilot training support apparatus 100. The pilot training support apparatus 100 is constituted of a computer such as a personal computer or a workstation. As illustrated in FIG. 1, the pilot training support apparatus 100 includes a controller 102, a memory 120, and a display 122.

The memory 120 is constituted of a random-access memory (RAM), a flash memory, a hard disk drive (HDD), or the like. The display 122 is constituted of a liquid crystal display, an organic electro luminescence (EL) display, or the like.

The controller 102 manages and controls the entire pilot training support apparatus 100 by a semiconductor integrated circuit including a central processing unit (CPU), a read-only memory (ROM) that stores programs and the like, and a RAM as a work area. In one example, the controller 102 may serve as a piloting skill measurer 104, a pilot aptitude measurer 106, a training proficiency level determiner 108, a curriculum creator 110, and a suitable course determiner 112. The piloting skill measurer 104 generates technical skill data obtainable by quantifying a piloting skill of an airplane of a trainee (subject) based on measurement data related to the piloting skill of the trainee. The pilot aptitude measurer 106 generates non-technical skill data obtainable by quantifying a pilot aptitude of the trainee based on measurement data related to the pilot aptitude of the trainee. The training proficiency level determiner 108 determines a training proficiency level of the trainee by comparing the technical skill data and the non-technical skill data with a reference value related to a training proficiency level. The curriculum creator 110 creates a curriculum of training content of the trainee in accordance with the training proficiency level of the trainee. The suitable course determiner 112 determines a suitable course of the trainee related to an airplane type based on the technical skill data and the non-technical skill data.

The piloting skill measurer 104 includes various sensors and input devices capable of acquiring various types of measurement data related to piloting skills of an airplane. The piloting skill measurer 104 stores, for example, data over time of operation amounts and operation speeds performed by a trainee during piloting of an airplane with respect to various operation switches and levers that control the engine, fuel system, power supply system, leg system, flaps, piloting system, a system for ventilation, cooling, and heating, communication navigation system, and illumination system mounted on the airplane in the memory 120 as data related to operation of the airplane.

The piloting skill measurer 104 also stores, for example, data over time of various instruments related to the altitude, position (latitude, longitude), velocity, elevation rate, turning rate, attitude, azimuth angle, acceleration, engine instrument, fuel instrument, power supply voltage instrument, communication navigation instrument, and warning and attention lamps in the airplane piloted by the trainee in the memory 120 as data related to indication of various instruments in the airplane.

The piloting skill measurer 104 also stores, for example, data over time of the line of sight (eyeball), head direction, grip strength, and voice volume of the trainee during piloting of the airplane in the memory 120 as biological data during piloting of the airplane.

The piloting skill measurer 104 also stores, for example, changes over time of the posture velocity and posture acceleration of the trainee during piloting of the airplane in the memory 120 as other recording data during piloting of the airplane.

The piloting skill measurer 104 may perform the measurement of the various types of data when the trainee pilots the airplane, or may perform the measurement using a virtual reality (VR) training apparatus or a flight simulator without using an airplane.

In addition, the memory 120 stores in advance various types of measurement data of piloting skills described above related to piloting skills of the airplane of a plurality of experienced pilots.

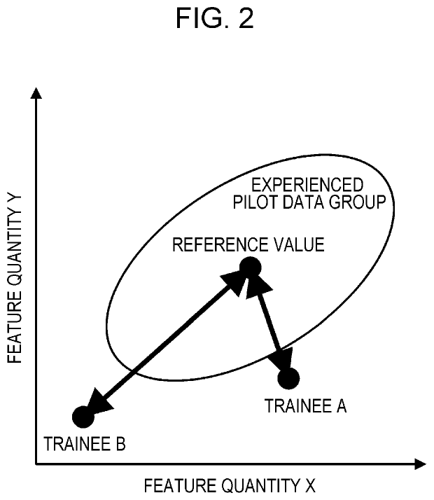

FIG. 2 is a diagram for explaining quantification of a piloting skill and quantification of a pilot aptitude. The piloting skill measurer 104 generates technical skill data obtainable by quantifying a piloting skill of an airplane of a trainee to be evaluated in an N-dimensional space based on various types of measurement data related to piloting skills of the trainee to be evaluated stored in the memory 120, and stores the technical skill data in the memory 120.

In one example, the piloting skill measurer 104 extracts measurement data related to one piloting skill or a plurality of piloting skills from the various types of measurement data related to the piloting skills of the airplane of the trainee to be evaluated (steering amounts of three steering axes, line of sight position, pupil size, and so forth). In addition, the piloting skill measurer 104 extracts, as reference data, measurement data related to the same type of piloting skill as that for which the above extraction has been performed, from the various types of measurement data related to the piloting skills of the airplane of the plurality of experienced pilots.

Then, the piloting skill measurer 104 compares the extracted measurement data related to the piloting skill of the trainee to be evaluated with the reference data to quantify the piloting skill of the trainee to be evaluated in the N-dimensional space. At this time, as illustrated in FIG. 2, the piloting skill measurer 104 quantifies the piloting skill of the trainee to be evaluated in accordance with the distance in the N-dimensional space between the extracted measurement data related to the piloting skill of the trainee to be evaluated and the reference data.

In one example, the piloting skill measurer 104 generates technical skill data by converting the piloting skill of the trainee to be evaluated into one of scores provided in a plurality of stages in accordance with the distance between the extracted measurement data related to the piloting skill of the trainee to be evaluated and the average value of the reference data, and stores the technical skill data in the memory 120.

For example, when the distance between the extracted measurement data related to the piloting skill of the trainee to be evaluated and the average value of the reference data is within a predetermined range, the piloting skill measurer 104 performs conversion such that the score of the piloting skill of the trainee to be evaluated is 10. When the distance between the extracted measurement data related to the piloting skill of the trainee to be evaluated and the average value of the reference data is larger than the predetermined range, the piloting skill measurer 104 performs conversion such that the score of the piloting skill of the trainee to be evaluated decreases as the distance increases. That is, in the case of FIG. 2, a trainee A having a shorter distance from the average value of the reference data has a higher score than the score of a trainee B having a longer distance from the average value of the reference data.

Similarly to the above, the piloting skill measurer 104 changes at least part of the types of data to be extracted from the various types of measurement data related to the piloting skills of the airplane, and performs score conversion on the extracted data. In the present embodiment, the piloting skill measurer 104 converts the scores of a technical skill (item A), a technical skill (item B), and a technical skill (item C) in accordance with the type of the extracted data or the combination of the extracted data. The number of scores to be converted is not limited to this.

The pilot aptitude measurer 106 includes various sensors and input devices capable of acquiring various types of measurement data related to pilot aptitudes. The pilot aptitude measurer 106 stores, for example, changes over time of the line of sight (eyeball); head direction; heart rate; respiration; blood oxygen concentration; blood pressure; perspiration; brain data including brain blood flow, potential reaction, and brain wave; spinal cord data including hemodynamic response; voice volume; voice tone; and facial expression in the memory 120 as biological data during operation and non-operation of the airplane.

The pilot aptitude measurer 106 also stores, for example, the percentage of correct answers and reaction time of test questions in the memory 120 as data related to predetermined test questions.

The pilot aptitude measurer 106 also stores, for example, results of a psychological test, a questionnaire, and hearing in the memory 120 as data related to subjective data.

In addition, the memory 120 stores in advance various types of measurement data described above related to pilot aptitudes of a plurality of experienced pilots.

The pilot aptitude measurer 106 generates non-technical skill data obtainable by quantifying a pilot aptitude of a trainee to be evaluated based on various types of measurement data related to pilot aptitudes of the trainee to be evaluated stored in the memory 120, and stores the generated non-technical skill data in the memory 120.

In one example, the pilot aptitude measurer 106 extracts measurement data related to one pilot aptitude or a plurality of types of pilot aptitudes from the various types of measurement data related to the pilot aptitudes of the trainee to be evaluated. In addition, the pilot aptitude measurer 106 extracts, as reference data, measurement data related to the same type of piloting skill as that for which the above extraction has been performed, from the various types of measurement data related to the pilot aptitudes of the plurality of experienced pilots.

Then, the pilot aptitude measurer 106 compares the extracted measurement data related to the pilot aptitude of the trainee to be evaluated with the reference data to quantify the pilot aptitude of the trainee to be evaluated. At this time, as illustrated in FIG. 2, the pilot aptitude measurer 106 quantifies the pilot aptitude of the trainee to be evaluated in accordance with the distance between the extracted measurement data related to the pilot aptitude of the trainee to be evaluated and the reference data.

In one example, the pilot aptitude measurer 106 generates non-technical skill data by converting the pilot aptitude of the trainee to be evaluated into one of scores provided in a plurality of stages in accordance with the distance between the extracted measurement data related to the pilot aptitude of the trainee to be evaluated and the average value of the reference data, and stores the non-technical skill data in the memory 120.

For example, when the distance between the extracted measurement data related to the pilot aptitude of the trainee to be evaluated and the average value of the reference data is within a predetermined range, the pilot aptitude measurer 106 performs conversion such that the score of the pilot aptitude of the trainee to be evaluated is 10. When the distance between the extracted measurement data related to the pilot aptitude of the trainee to be evaluated and the average value of the reference data is larger than the predetermined range, the pilot aptitude measurer 106 performs conversion such that the score of the pilot aptitude of the trainee to be evaluated decreases as the distance increases. That is, in the case of FIG. 2, a trainee A having a shorter distance from the average value of the reference data has a higher score than the score of a trainee B having a longer distance from the average value of the reference data.

Similarly to the above, the pilot aptitude measurer 106 changes at least part of the types of data to be extracted from the various types of measurement data related to the pilot aptitudes, and performs score conversion on the extracted data. In the present embodiment, the pilot aptitude measurer 106 converts the scores of a non-technical skill (item X), a non-technical skill (item Y), and a non-technical skill (item Z) in accordance with the type of the extracted data or the combination of the extracted data. The number of scores to be converted is not limited to this.

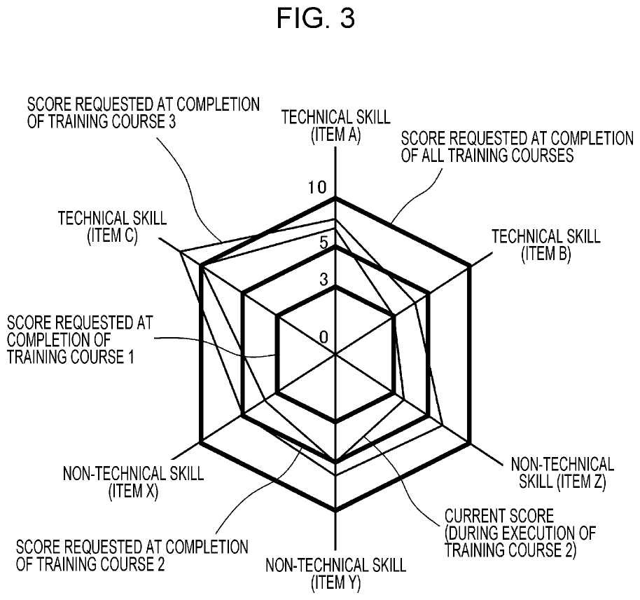

FIG. 3 is an explanatory diagram for explaining training proficiency level determination and curriculum creation. As illustrated in FIG. 3, in the present embodiment, a training course including a plurality of stages in training of a trainee is provided. Values of a technical score and a non-technical score requested at completion of each training course are set in advance as reference values related to a training proficiency level. In the present embodiment, at completion of a training course 1, the value of each score of the technical score (item A) to the technical score (item C) and the non-technical score (item X) to the non-technical score (item Z) is requested to be 3 or more. Likewise, the value of each score of the technical score (item A) to the technical score (item C) and the non-technical score (item X) to the non-technical score (item Z) is requested to be 5 or more at completion of a training course 2, and is requested to be 10 or more at completion of a training course 3.

The training proficiency level determiner 108 determines the training proficiency level of the trainee to be evaluated by comparing the technical skill data and the non-technical skill data of the trainee to be evaluated stored in the memory 120 with the reference value related to the training proficiency level.

For example, as illustrated in FIG. 3, when the trainee to be evaluated is currently executing the training course 2, the training proficiency level determiner 108 compares the reference value related to the training proficiency level corresponding to the training course being executed with the technical skill data and the non-technical skill data of the trainee to be evaluated stored in the memory 120. In the case of FIG. 3, the training proficiency level determiner 108 determines an actual result of a current training proficiency level of the trainee such that the scores of the technical skill (item A), the technical skill (item C), the non-technical skill (item X), and the non-technical skill (item Y) are equal to or higher than the score of the reference value related to the training proficiency level corresponding to the training course 2 being executed, and stores the actual result in the memory 120. In contrast, the training proficiency level determiner 108 determines an actual result of a current training proficiency level of the trainee such that the scores of the technical skill (item B) and the non-technical skill (item Z) are less than the score of the reference value related to the training proficiency level corresponding to the training course 2 being executed, and stores the actual result in the memory 120. Then, the determination result of the actual result of the current training proficiency level of the trainee stored in the memory 120 can be displayed by the display 122 as illustrated in FIG. 3.

The memory 120 stores in advance how the various types of measurement data described above related to the piloting skills of the airplane of the plurality of experienced pilots have transitioned in accordance with the progress stage of each training course. In addition, the memory 120 stores in advance transition data indicating how the various types of measurement data described above related to the pilot aptitudes of the plurality of experienced pilots have transitioned in accordance with the progress stage of each training course and how the technical skill data and the non-technical skill data have transitioned in accordance with the progress stage of each training course.

Based on the current technical skill data and the current non-technical skill data of the trainee to be evaluated and the current progress stage of the training course of the trainee to be evaluated, the training proficiency level determiner 108 refers to the above-described transition data related to the experienced pilots stored in the memory 120, predicts transition of a future proficiency level of the technical skill data and the non-technical skill data of the trainee to be evaluated, and stores the transition as predicted transition data (prediction result) in the memory 120. The predicted transition data stored in the memory 120 can be displayed by the display 122.

The curriculum creator 110 creates a curriculum of training content of the trainee in accordance with the training proficiency level of the trainee to be evaluated stored in the memory 120.

For example, the curriculum creator 110 creates a curriculum of training content of the trainee for an item of a technical skill or a non-technical skill determined to have a proficiency level less than the score of the reference value related to the training proficiency level.

The memory 120 stores in advance a predetermined curriculum provided in accordance with each item of the technical skill and the non-technical skill. The curriculum creator 110 creates a curriculum of combining a curriculum corresponding to the item of the technical skill or the non-technical skill determined to have a proficiency level less than the score of the reference value related to the training proficiency level.

That is, the curriculum creator 110 creates a curriculum for improving the score of the item of the technical skill or the non-technical skill determined to have the proficiency level less than the score of the reference value related to the training proficiency level, and stores the curriculum in the memory 120. The curriculum stored in the memory 120 can be displayed by the display 122.

As described above, according to the present embodiment, it is possible to propose to the trainee the curriculum for improving the score of the item of the technical skill or the non-technical skill determined to have the proficiency level less than the score of the reference value related to the training proficiency level. Accordingly, the curriculum corresponding to the technical skill or the non-technical skill having the low proficiency level can be intensively executed, and thus it is possible to improve the training efficiency of the trainee. When the training efficiency of the trainee is improved, the progress speed of various skills of the trainee is increased. Thus, it is possible to reduce the dismissal rate of trainees of airplanes.

The curriculum creator 110 also creates a curriculum of training content of the trainee in accordance with the actual result of the current training proficiency level of the trainee to be evaluated stored in the memory 120 and the predicted transition data stored in the memory 120.

For example, the curriculum creator 110 creates a curriculum by combining a curriculum corresponding to an item of a technical skill or a non-technical skill whose proficiency level does not reach the score of the reference value even in the future with reference to the predicted transition data stored in the memory 120 for the item of the technical skill or the non-technical skill determined to have the proficiency level less than the score of the reference value related to the training proficiency level. Accordingly, a reduced amount of curriculum can be proposed to the trainee. This can suppress the possibility that the volume of proposed curriculum excessively increases and the training efficiency of the trainee is rather reduced. Thus, the dismissal rate of trainees of airplanes can be reduced.

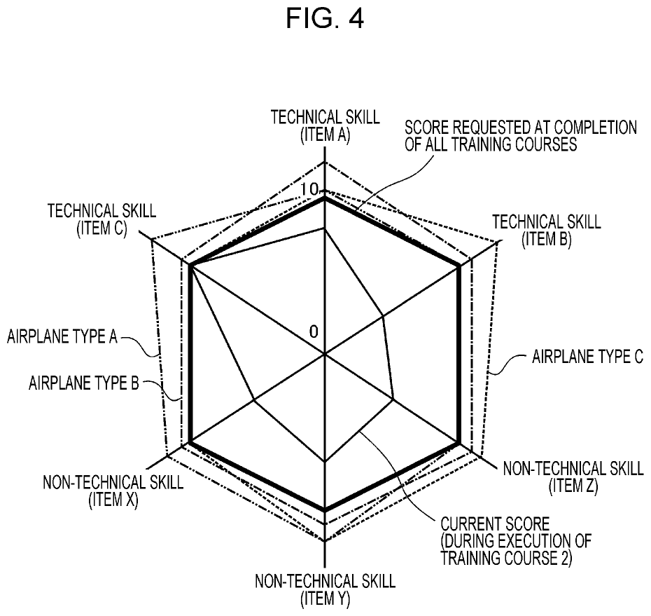

FIG. 4 is an explanatory diagram for explaining suitable course determination by the suitable course determiner 112. In the present embodiment, a plurality of courses to which trainees are assigned after completion of training are provided in accordance with an airplane type. In one example, three airplane types are provided: airplane type A (fighter plane), airplane type B (transport plane), and airplane type C (rescue plane).

The suitable course determiner 112 extracts, for each course corresponding to the airplane type to which each experienced pilot has been assigned, various types of measurement data related to the piloting skills and the pilot aptitudes of the airplane of the experienced pilot stored in the memory 120. Then, as illustrated in FIG. 4, the suitable course determiner 112 creates a course-specific reference value for each course corresponding to the airplane type and stores the course-specific reference value in the memory 120.

The suitable course determiner 112 compares the course-specific reference value stored in the memory 120 with the technical skill data and the non-technical skill data related to the trainee to be evaluated stored in the memory 120, determines a suitable course of the trainee, and stores the suitable course in the memory 120. Then, the suitable course of the trainee stored in the memory 120 can be displayed by the display 122.

For example, a suitable course can be determined based on the type of technical skill data or non-technical skill data of the best score of the trainee to be evaluated. In one example, when the type of the best score of the trainee to be evaluated is the technical skill (item C), the suitable course may be determined as the airplane type A; when the type of the best score of the trainee to be evaluated is the non-technical skill (item Z), the suitable course may be determined as the airplane type C; and when the type of the best score of the trainee to be evaluated is the technical skill (item A), the suitable course may be determined as the airplane type B.

As described above, in the present embodiment, by proposing the suitable course to the trainee, it is possible to improve the motivation of the trainee for training. Accordingly, it is possible to reduce the dismissal rate of trainees and to improve the training efficiency.

Although the embodiment of the disclosure has been described above with reference to the accompanying drawings, the disclosure is not limited to the embodiment. It is apparent to those skilled in the art that various changes and modifications can be made within the scope described in the claims, and it is understood that these naturally belong to the technical scope of the disclosure.

In the above-described embodiment, each type of fighter plane, transport plane, and rescue plane is provided as the trainee's suitable course related to the airplane type. However, the specific content of the airplane type is not limited thereto.

The types of measurement data related to the piloting skill of the airplane and the types of measurement data related to the pilot aptitude described in the above embodiment are merely examples, and the disclosure is not limited thereto.

In the above-described embodiment, the measurement data related to the piloting skill of the airplane of the trainee and the measurement data related to the pilot aptitude of the trainee are converted into scores and quantified. However, the disclosure is not limited thereto. For example, the ratio of the magnitude of the value of the measurement data related to the piloting skill of the trainee or the measurement data related to the pilot aptitude of the trainee to the average value of the reference data may be derived and quantified.

A controller 102 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the controller 102 including a piloting skill measurer 104, a pilot aptitude measurer 106, a training proficiency level determiner 108, a curriculum creator 110, and a suitable course determiner 112. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions implemented of the modules illustrated in FIG. 1.

According to the disclosure, it is possible to reduce the dismissal rate and improve the training efficiency of pilot training subjects of airplanes.

1. A pilot training support apparatus comprising:
a piloting skill measurer configured to generate technical skill data obtainable by quantifying a piloting skill of a subject in piloting an airplane based on measurement data related to the piloting skill of the subject;
a pilot aptitude measurer configured to generate non-technical skill data obtainable by quantifying a pilot aptitude of the subject based on measurement data related to the pilot aptitude of the subject;
a training proficiency level determiner configured to determine a training proficiency level of the subject by comparing the technical skill data and the non-technical skill data with reference values related to a training proficiency level; and
a curriculum creator configured to create a curriculum of training content for the subject in accordance with the training proficiency level of the subject.

2. The pilot training support apparatus according to claim 1,
wherein the training proficiency level determiner is configured to
determine a currently achieved actual result of the training proficiency level of the subject and make a prediction about a future transition of the training proficiency level of the subject by comparing the technical skill data and the non-technical skill data with the respective reference values, and
wherein the curriculum creator is configured to
create the curriculum of the training content for the subject in accordance with the currently achieved actual result of the training proficiency level of the subject and the prediction about the future transition of the training proficiency level of the subject.

3. The pilot training support apparatus according to claim 1, comprising:
a suitable course determiner configured to determine a suitable course for the subject related to an airplane type based on the technical skill data and the non-technical skill data.

4. The pilot training support apparatus according to claim 2, comprising:
a suitable course determiner configured to determine a suitable course for the subject related to an airplane type based on the technical skill data and the non-technical skill data.

5. The pilot training support apparatus according to claim 3, wherein the suitable course determiner is configured to determine, as the suitable course, one of multiple courses by comparing the technical skill data and the non-technical skill data with course-specific reference values provided for each of the multiple courses.

6. The pilot training support apparatus according to claim 4, wherein the suitable course determiner is configured to determine, as the suitable course, one of multiple courses by comparing the technical skill data and the non-technical skill data with course-specific reference values provided for each of the multiple courses.

7. A pilot training support apparatus comprising:
circuitry configured to
generate technical skill data obtainable by quantifying a piloting skill of a subject in piloting an airplane based on measurement data related to the piloting skill of the subject,
generate non-technical skill data obtainable by quantifying a pilot aptitude of the subject based on measurement data related to the pilot aptitude of the subject,
determine a training proficiency level of the subject by comparing the technical skill data and the non-technical skill data with reference values related to a training proficiency level, and
create a curriculum of training content for the subject in accordance with the training proficiency level of the subject.
